(19) United States
(12) Patent Application Publication
(10) Pub. No.: US 2016/0085801 A1
(43) Pub. Date: Mar. 24, 2016

(54) SYSTEM, METHOD AND COMPUTER PROGRAM PRODUCT FOR UPDATING DATABASE OBJECTS WITH REPORT AGGREGATIONS

(71) Applicant: salesforce.com, inc., San Francisco, CA (US)

(72) Inventors: Nicholas Hellbusch, Huntington Beach, CA (US); Gaurav Salkar, Fremont, CA (US); Paul Hoade, Milford (GB)

(21) Appl. No.: 14/495,760

(22) Filed: Sep. 24, 2014

(51) Int. Cl. G06F 17/30

(52) U.S. Cl. CPC G06F 17/30412; G06F 17/30371

(57) ABSTRACT

In accordance with embodiments, there are provided mechanisms and methods for updating database objects with report aggregations. These mechanisms and methods for updating database objects with report aggregations can enable high-level configurations defining the use of report aggregations in specified database objects. This can allow user-friendly configurations of data aggregations and uses thereof, efficient generation of reports having data aggregations, and/or aggregations that are not limited based on user access privileges but that summarize all desired data.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to aggregating data in a database system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Oftentimes, users desire to build reports using data stored in database systems. In particular, these reports generally aggregate data stored in a database system for summarizing the data in a way that is meaningful for the user viewing the report. Just by way of example, sales-related data may be aggregated in a report to present to a user a total sales value.

Unfortunately, existing techniques for reporting on aggregate data have exhibited various limitations. For example, in some database systems the data is distributed across multiple records, tables, etc. which requires a large volume of database transactions to aggregate the data. The distributed nature of the data, and the resulting volume of database transactions to aggregate the data, slows the creation of any report having the aggregated data when the data aggregation process is performed on-demand in conjunction with a request for the report.

As another example, the data being aggregated for a report may include subsets thereof that are accessible based on different access privileges. This may cause different subsets of the data to be aggregated in a report depending on the particular user that generates the report, such that different users will get different aggregate values when running the same report and will not get an aggregate value based on all of the desired data.

In other examples, an aggregate generated by a report may only be able to be included in a database object that is specifically defined as a parent object to the object(s) storing the data to be aggregated; minimal aggregate functions (e.g. sum, count, etc.) may be available; defining the aggregate function and/or filtering criteria associated therewith may require coding by a user, scheduling of the data aggregation may be unavailable to users, etc.

In yet another example, functions relating to aggregate data already included in a report may be limited. For example, the aggregate data may be only be viewable and extractable by a user, such that there may be no ability for the user to perform further operations, configurations, etc. in relation to the aggregate data once it is included in the report.

Accordingly, it is desirable to provide techniques enabling user-friendly configurations of data aggregations and uses thereof, efficient generation of reports having data aggregations, aggregations that are not limited based on user access privileges but that summarize all desired data, and/or any of the other deficiencies noted above or any other deficiencies associated with existing techniques to be overcome.

### BRIEF SUMMARY

In accordance with embodiments, there are provided mechanisms and methods for updating database objects with report aggregations. These mechanisms and methods for updating database objects with report aggregations can enable high-level configurations defining the use of report aggregations in specified database objects. This can allow user-friendly configurations of data aggregations and uses thereof, efficient generation of reports having data aggregations, and/or aggregations that are not limited based on user access privileges but that summarize all desired data.

In an embodiment and by way of example, a method for updating database objects with report aggregations is provided. In use, a definition of a report that aggregates source data from a plurality of source objects in a database system is received from a user. Additionally, configuration information mapping the aggregated data in the report to at least one destination object is received from the user. Further, the report is executed to generate the aggregated data. In response to the generation of the aggregated data, each destination object is automatically updated with the aggregated data based on the configuration information.

While one or more implementations and techniques are described with reference to an embodiment in which updating database objects with report aggregations is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for updating database objects with report aggregations, in accordance with an embodiment;

FIG. 2 illustrates a method for receiving a user definition of a report that aggregates data, in accordance with an embodiment;

FIG. 3 illustrates a method for receiving a configured use for a report from a user, in accordance with an embodiment;

FIG. 4 illustrates a method for executing a report that aggregates data to update a database object with the aggregated data, in accordance with an embodiment;

FIG. 5 is a screen shot illustrating an exemplary user interface for receiving a user definition of a report that aggregates data, in accordance with an embodiment;

FIG. 6 is a screen shot illustrating an exemplary user interface for receiving a configured use for a report from a user, in accordance with an embodiment;

FIG. 7 is a screen shot illustrating an exemplary user interface reporting on execution of a report that aggregates data and the updating of a database object with the aggregated data, in accordance with an embodiment;

FIG. 8 is a screen shot illustrating an exemplary user interface showing multiple user-configured uses for reports that aggregate data, in accordance with an embodiment;

FIG. 9 is a screen shot illustrating an exemplary user interface showing a database object that has been updated with report aggregations, in accordance with an embodiment;

FIG. 10 illustrates a block diagram of an example of an environment wherein an on-demand database service might be used; and

FIG. 11 illustrates a block diagram of an embodiment of elements of FIG. 10 and various possible interconnections between these elements.

### DETAILED DESCRIPTION

### General Overview

Systems and methods are provided for updating database objects with report aggregations.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing updating database objects with report aggregations will be described with reference to example embodiments.

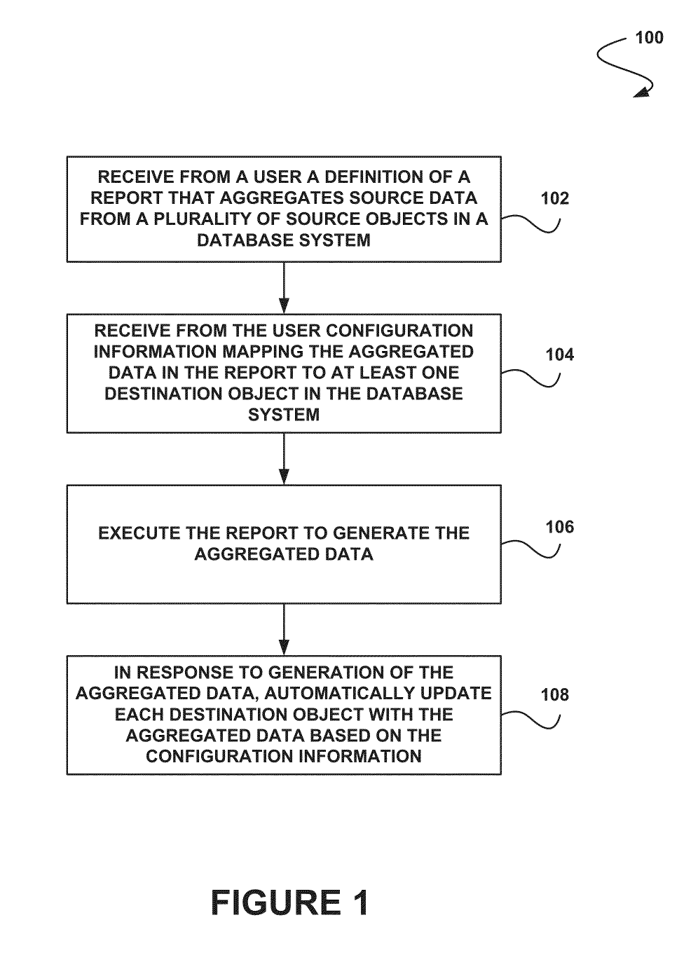

FIG. 1 illustrates a method 100 for updating database objects with report aggregations, in accordance with an embodiment. As shown in operation 102, a definition of a report that aggregates source data from a plurality of source objects in a database system is received from a user. For example, the report may be executable such that when the report is run the source data is aggregated to form aggregated data (also referred to herein below as a data aggregate).

In one embodiment, the definition of the report may specify a field of the source objects (e.g. tables) storing the source data that is to be aggregated. For example, the definition of the report may specify a name of the source objects and a name of the fields (e.g. column) therein storing the source data. Of course, however, the source data may be specified by referencing the source data or a location thereof in any desired manner.

In another embodiment, the definition of the report may specify an aggregate function to be applied to the source data for aggregating the source data. Such aggregate function may include sum, count, etc. In yet another embodiment, the definition of the report may specify a level of aggregation for the source data, such as a parameter by which the source data is aggregated. Just by way of example, the parameter may be another field of the source objects.

As a further option, the definition of the report may further specify filtering criteria for filtering the source data prior to being aggregated by the aggregate function. Each filtering criterion, for example, may reference a field of the source data and a requirement for the data therein in order for such data to be included in the aggregation.

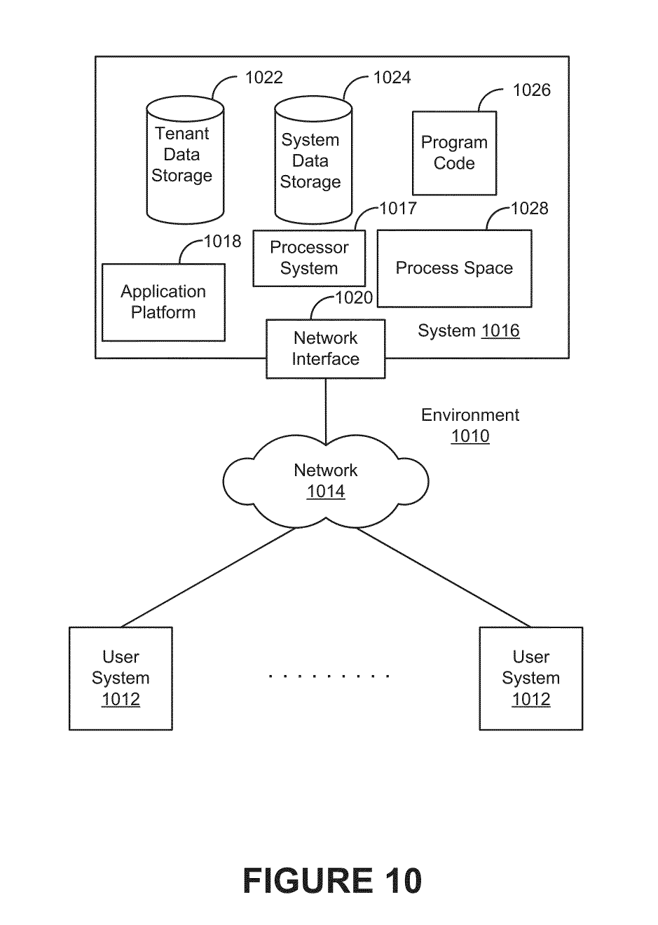

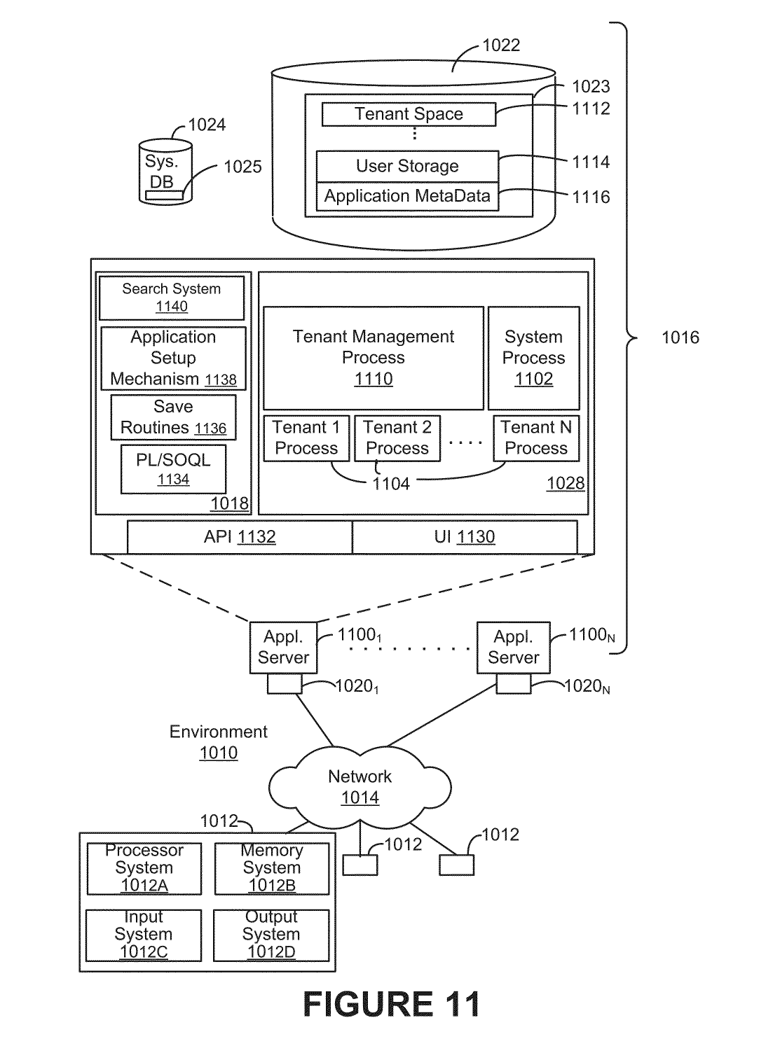

Further, it should be noted that in the context of the present description, the database system may be any database storing objects having data on which the aforementioned report may be executed. In one exemplary embodiment, the database system may be the multi-tenant on-demand database system described below in FIGS. 10-11. As an option, the report definition may be stored in the database system as metadata.

Additionally, as shown in operation 104, configuration information mapping the aggregated data in the report to at least one destination object is received from the user. Similar to the source objects described above, the destination object may also be a table of the database system. As another option, the destination object may be a specific record of the database system. In any case, the destination object may be specified in the configuration information by name, location, unique identifier, or any other reference thereto.

As noted above, the configuration information includes a mapping of the aggregated data in the report (i.e. generated by the report) to one or more destination objects. Each mapping may specify both the aggregated data in the report and the destination object or portion thereof to be updated with the aggregated data. In one embodiment, the report may be stored in a report object of the database system, such that the mapping in the configuration information may specify, and thus associate (e.g. link), a field of the report object designated for storing the aggregated data to a field of the destination object. Moreover, the configuration information may be stored in a configuration object of the database system, may be stored as metadata, etc.

Further, as shown in operation 106, the report is executed to generate the aggregated data. For example, executing the report may include generating a query in accordance with the definition of the report. In the context of the report definition specifying a field of the source objects storing the source data, executing the report may include retrieving the source data from the field of the source objects, an applying the aggregate function to the source data at the specified level of aggregation.

In another example, where the definition of the report specifies the source data, aggregate function, level of aggregation, and optionally filtering criteria, the query may select from the source data in the database system a portion thereof (meeting any specified filtering criteria), and then may aggregate that selected portion of source data at the level of aggregation (e.g. by the specified parameter) using the aggregate function. As described above, the report, once executed, may in one embodiment be stored in a report object of the database system, whereby the aggregated data may be stored in a field of the report object.

In response to the generation of the aggregated data and as shown in operation 108, each destination object is automatically updated with the aggregated data based on the configuration information. Thus, for each destination object mapped to the aggregated data by the configuration information, such destination object may be automatically updated with the aggregated data. In an embodiment where the mapping specifies a particular portion of the destination object (e.g. field), then that particular portion of the destination object may be automatically updated with the aggregated data. In furtherance of the aforementioned embodiment, where the aggregated data is stored in a field of a report object, then updating each destination object mapped to the aggregated data may include retrieving the aggregated data from the field of the report object and storing the retrieved aggregated data in the particular portion of the destination object.

To this end, the above method 100 may allow a user to specify a data aggregation to be included in a report, as well as a particular destination object, or even portion thereof, to be automatically updated with aggregated data resulting from execution of the report. Further, the aggregated data may be generated from source data that is stored across multiple source objects. These source objects may each be related to the destination object, and the relationships may optionally be at different levels. For example, each source object may be directly related to the source object or indirectly related to the destination object through references spanning across one or more other objects. The method 100 described above may be implemented through a graphical user interface (GUI) for providing the user point-and-click functionality which allows the user to specify a data aggregate to be created and to specify the destination object(s) to which that data aggregate is to be made available. In this way, the user may not be required to manually write custom code to perform the aforementioned complex operations which retrieve and aggregate data (e.g. across multiple levels of source objects in the system) and which populate one or more specified destination objects with that aggregate data.

Further, by storing the aggregated data in a specified destination object, the aggregated data may be actionable (e.g. functions, configurations, etc. relating to the aggregate data stored in that destination object may be enabled). Just by way of example, a predefined process may be configured to identify changes to the destination object, such as changes including the storage, updating, etc. of the aggregate data therein, and then process the aggregate data. In some use cases, this processing may include decision making, generating notifications, etc.

It should be noted that while only a single aggregation is described above with respect to the report, in other embodiments the report may perform any number of aggregations which may use the same or different aggregate function, and/or which may be across the same or different source data, and/or which may be at the same or different levels of aggregation and/or with optionally with the same or different filtering criteria. Thus, execution of the report may return one or many data aggregates, per the definition of the report received from the user. In the context of the report generating multiple data aggregates, the configuration information may map each of the data aggregates to one or more destination objects, for storing the same in the destination objects in response to generation of the data aggregate.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

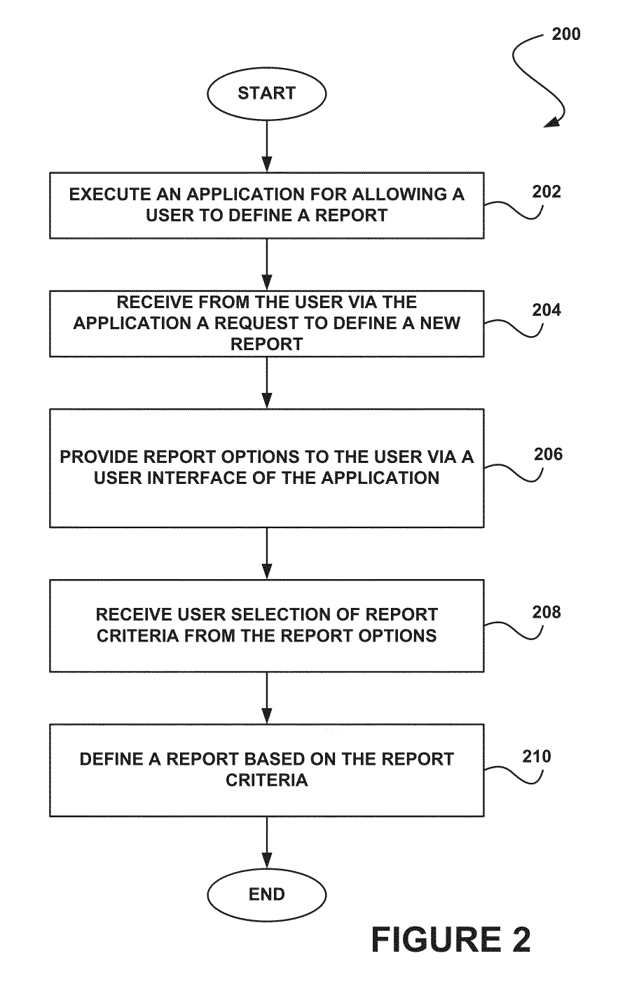

FIG. 2 illustrates a method 200 for receiving a user definition of a report that aggregates data, in accordance with an embodiment. As an option, the method 200 may be carried out in the context of operation 102 of FIG. 1. Of course, however, the method 200 may be carried out in any desired environment. It should also be noted that the aforementioned definitions may apply during the present description.

As shown in operation 202, an application is executed for allowing a user to define a report. The application may be executed on a platform providing a database system storing the data, as an option. For example, the application may be hosted and run by the database system, and made accessible by the database system to users of the database system. One example of this application may be the report builder functionality of the Salesforce™ Reports and Dashboards service provided by Salesforce.com™. Further, the application may be executed, or an instance thereof may be executed when the application is shared by multiple users, in response to the application being accessed by the user.

Then, in operation 204, a request to define a new report is received from the user. For example, the application may include a user interface with a selectable option for defining a new report. In response to receipt of the request, report options are provided to the user via a user interface of the application. Note operation 206. The report options may allow the user to indicate source data for the report, filtering criteria for the source data, a specific aggregate function to be applied to the source data, and/or a level of aggregation at which to apply the aggregate function. In various embodiments, the report options may be provided to the user as drop down boxes, text boxes, lists, or any other user-friendly options allowing the user to visually define a new report without having the manually write the definition in code supported by the database system.

In operation 208, a user selection of report criteria is received from the report options. Thus, the user may indicate from the report options source data for the report, filtering criteria for the source data, a specific aggregate function to be applied to the source data, and/or a level of aggregation at which to apply the aggregate function. Finally in operation 210, a report is defined based on the report criteria. The report may be defined by storing the report criteria as metadata. It should be noted that while the present method 200 is described above with respect to a report defined to generate a single data aggregate, other embodiments are contemplated in which operations 206-208 could be performed any number of times to allow the user to define a report that generates multiple data aggregates.

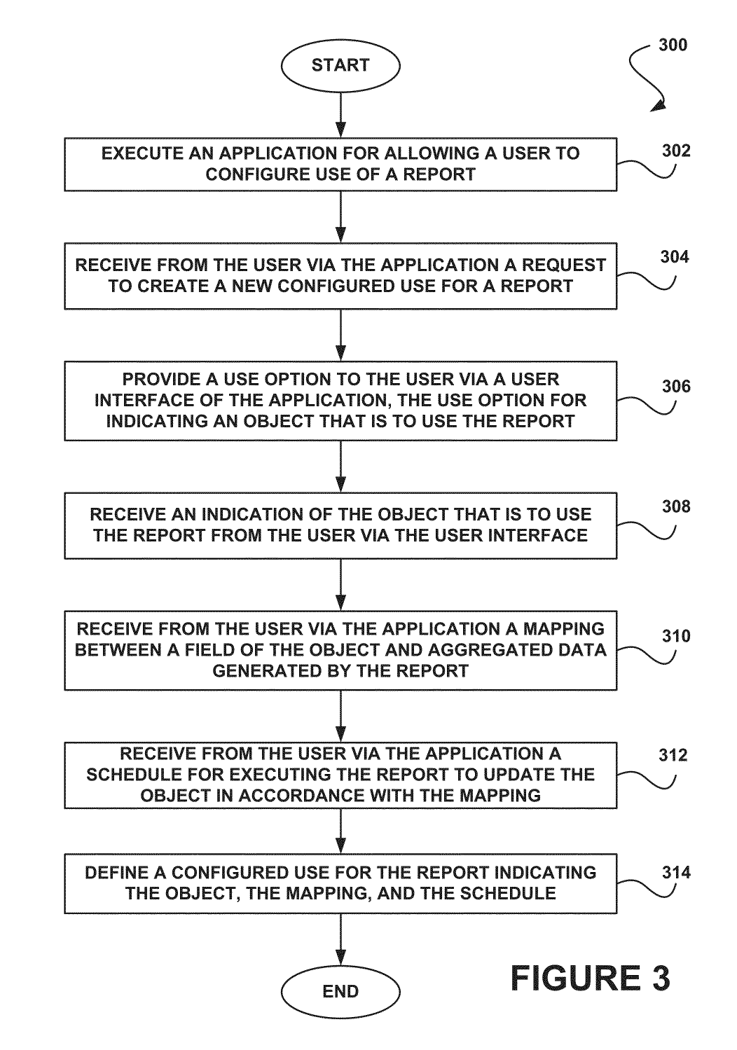

FIG. 3 illustrates a method 300 for receiving a configured use for a report from a user, in accordance with an embodiment. As an option, the method 300 may be carried out in the context of operation 104 of FIG. 1. Of course, however, the method 300 may be carried out in any desired environment. It should also be noted that the aforementioned definitions may apply during the present description.

Initially in operation 302, an application is executed for allowing a user to configure use of a report. The application may be the same application as that described above with respect to the method 200 of FIG. 2. Alternatively, the application may be a different application, but may optionally also be hosted and run by the database system for use by users of the database system. Further, the application may be executed, or an instance thereof may be executed when the application is shared by multiple users, in response to the application being accessed by the user.

Then, in operation 304, a request to create a new configured use for a report is received from the user. For example, the application may include a user interface with a selectable option for creating a new configured use for a report. In response to receipt of the request, a use option is provided to the user via a user interface of the application, where the user option is for indicating an object that is to use the report. Note operation 306. In various embodiments, the use option may include a list, textbox, or any other type of input field for allowing the user to enter an object that is to use the report.

Further, as shown in operation 308, an indication of the object that is to use the report is received from the user via the user interface. Then, in operation 310, a mapping between a field of the object and aggregated data generated by the report is received from the user via the application. While a single mapping for a single destination object is described with reference to the present method 300, it should be noted that operations 308-310 may be repeated for allowing the user to specify mappings between different aggregated data generated by the report and the different fields of the object.

Still yet, as shown in operation 312, a schedule for executing the report to update the object in accordance with the mapping is received from the user via the application. The schedule may indicate a day/time to execute the report. As a further option, the schedule may indicate that the report is to be executed a single time or that the report execution is to be recurring.

Finally, in operation 314, a configured use for the report indicating the object, the mapping, and the schedule is defined. For example, the indication of the object, the mapping, and the schedule may be stored as configuration information. Further, such definition may be stored as metadata. Optionally, operations 308-314 may be repeated for defining multiple configured uses for the report by multiple different objects.

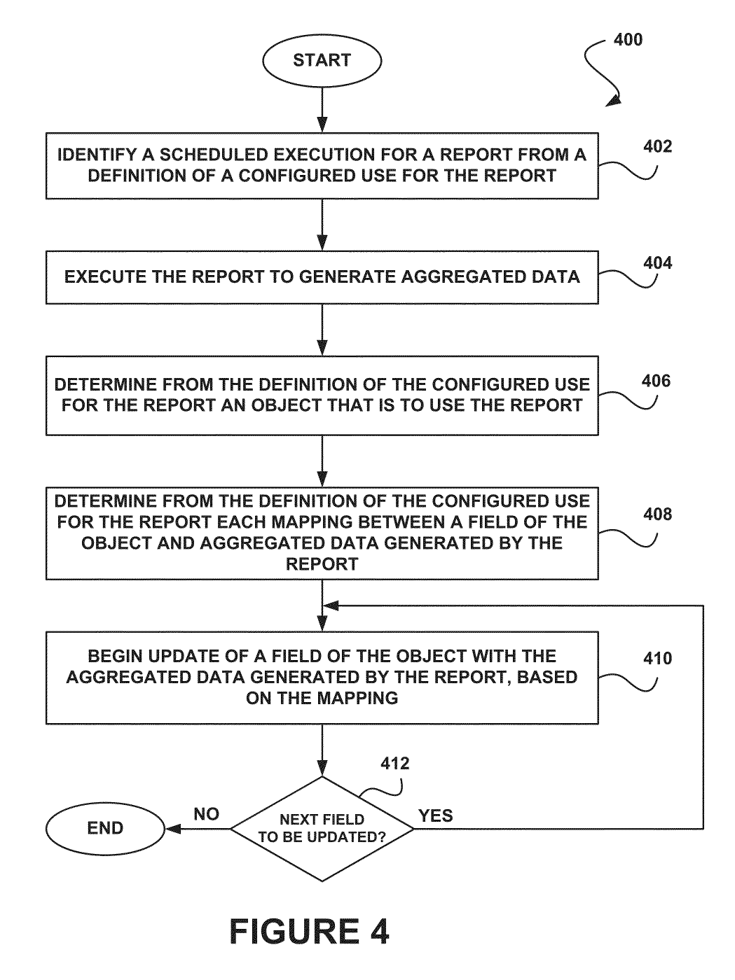

FIG. 4 illustrates a method 400 for executing a report that aggregates data to update a database object with the aggregated data, in accordance with an embodiment. As an option, the method 400 may be carried out in the context of operation 106-108 of FIG. 1, or in another embodiment in the context of FIGS. 2-3. Of course, however, the method 400 may be carried out in any desired environment. Again, it should be noted that the aforementioned definitions may apply during the present description.

As shown in operation 402, a scheduled execution for a report is identified from a definition of a configured use for the report. For example, it may be identified from the configured use for the report (e.g. as defined by the method 300 of FIG. 3) that the current day/time is that at which the report has been scheduled to be executed. Optionally, the report (or an identifier thereof) may be added to a job queue for execution of the report in accordance with the schedule. In response, the report is executed to generate aggregated data. Note operation 404. In particular, the report may be that defined by the method 200 of FIG. 2.

In operation 406, an object that is to use the report is determined from the definition of the configured use for the report, and further in operation 408 each mapping between a field of that object and aggregated data generated by the report is also determined from the definition of the configured use for the report. An update to a field of the object with the aggregated data generated by the report is then initiated in operation 410, based on the mapping. The update may include populating the field of the object with the aggregated data, for example.

It is then determined whether there is a next field to be updated with aggregated data (per operation 408), and if so, operations 410 is repeated to update that next field with the aggregated data that has been mapped thereto. Once each field specified by the configured user for the report has been updated, the method 400 ends. Of course, it should be noted that operations 406-412 may be repeated for each object that is to use the report, as indicated by the definition of the configured use for the report.

In this way, the report may be executed according to the schedule for updating each destination object with aggregated data from the report. Further, when the schedule specifies a recurring execution of the report to generate the aggregated data, in response to each repeated execution of the report, each destination object may be updated with the generated aggregated data. This may allow the destination object to be refreshed with a new instance of the aggregated data generated from a latest execution of the report.

As a further option, the execution of the report and the updating of each destination object with the aggregated data may be logged. The logging may, for example, be of a status of the execution of the report and a status of the updating of the destination object with the aggregated data. As a further example, the logging may be of errors occurring during the execution of the report and the updating of the at least one destination object with the aggregated data.

### Exemplary Use Case

A user of the database system wants to see the revenue from various products for each company on a company object record. This revenue data is not stored directly on the company object record. It has to be computed by aggregating revenue values from various related records associated with this company and summing them up for every product.

In a typical scenario, one would need to write custom code to query product revenue records, perform the computation and the save the computed values on each company record. This is not a very scalable approach to handle a use case like this. Also it won't solve the problem for other similar use cases without increasing the development effort and complexity.

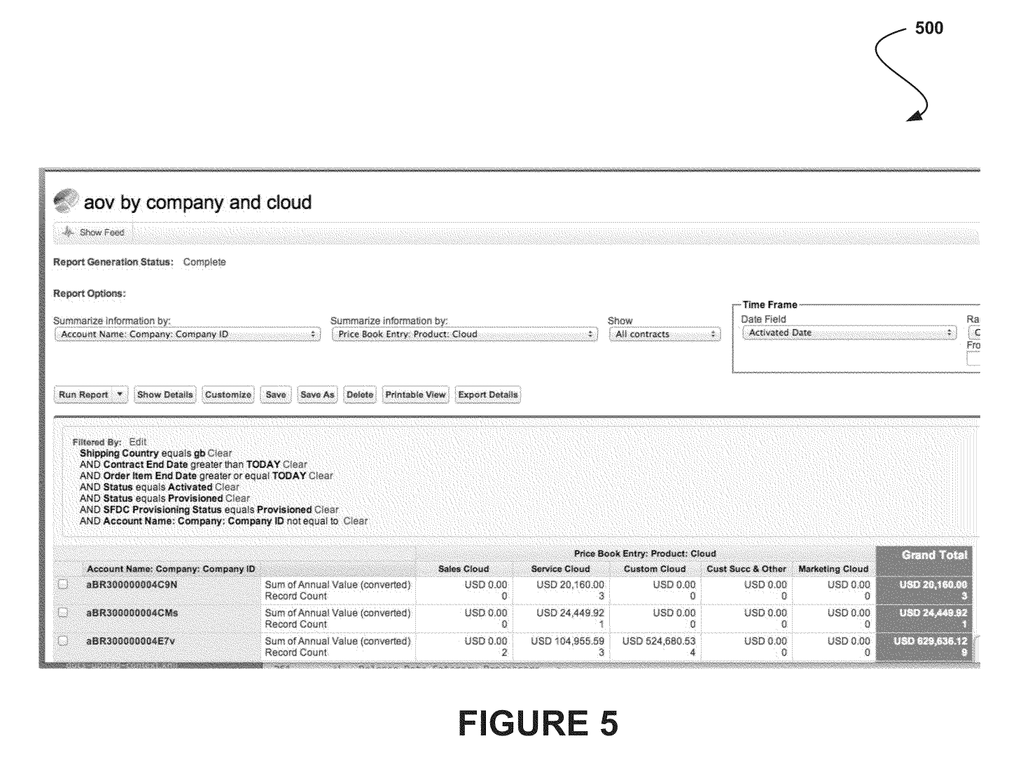

FIGS. 5-9 show how the methods described above can provide a configurable and metadata driven approach to this use case.

FIG. 5 is a screen shot 500 illustrating an exemplary user interface for receiving a user definition of a report that aggregates data, in accordance with an embodiment. As shown, a user creates a report to break the average order value (AOV) data by company and products.

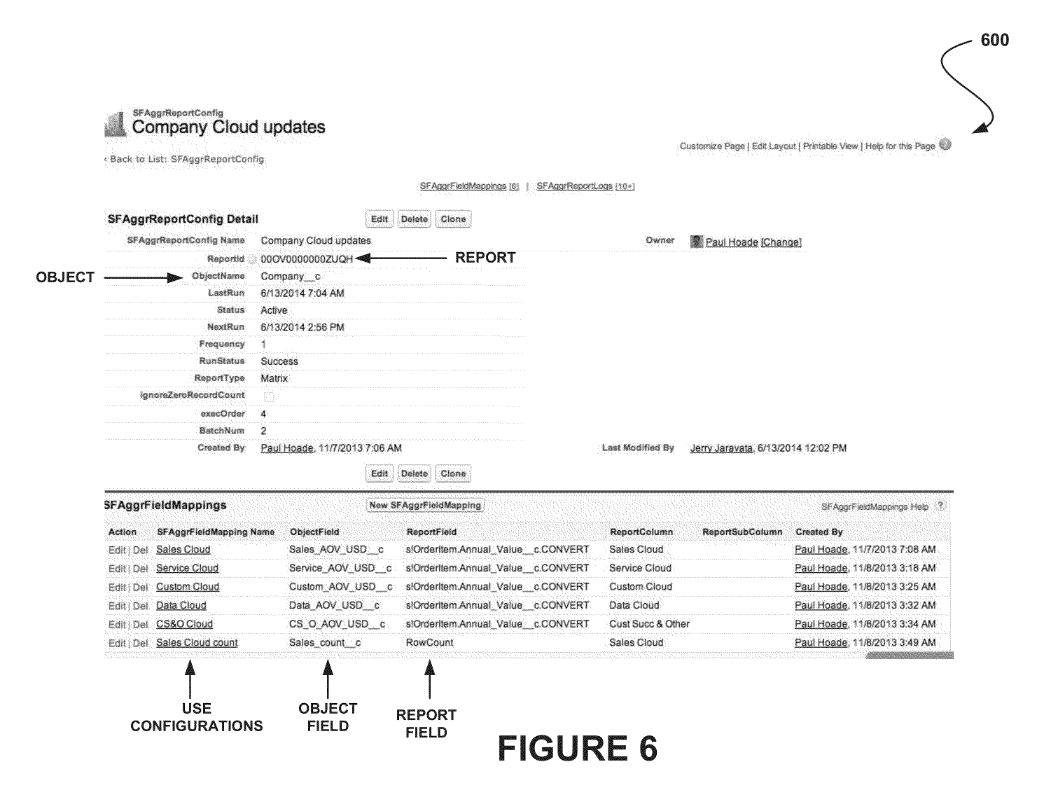

FIG. 6 is a screen shot 600 illustrating an exemplary user interface for receiving a configured use for a report from a user, in accordance with an embodiment. As shown, a configuration object is then provided that allows the user to create a configuration record that links the report (created from FIG. 5) to the actual object (Company) and map the data from the report into company object fields. A batch process can also be scheduled to run which carries out the data aggregation based on the metadata that defined in the configuration record and to update the computed values on company records in the database system.

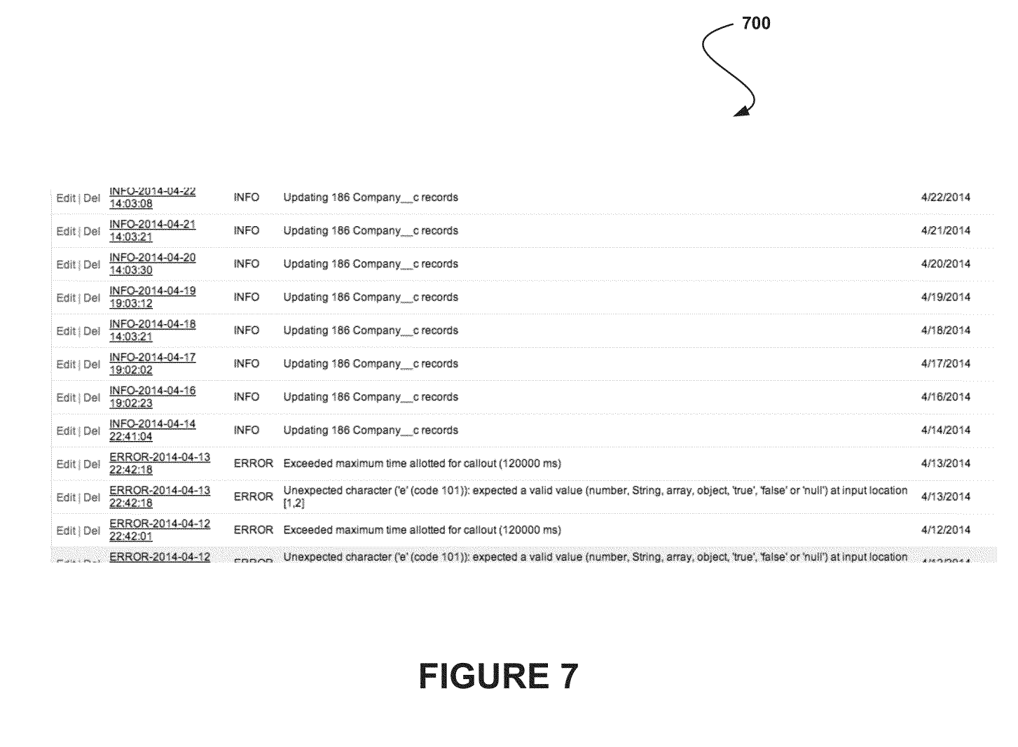

FIG. 7 is a screen shot 700 illustrating an exemplary user interface reporting on execution of a report that aggregates data and the updating of a database object with the aggregated data, in accordance with an embodiment. As shown, a status and error report for the batch process described above is generated for every configuration entry that is created and allows the user to monitor the data aggregation and object updating process.

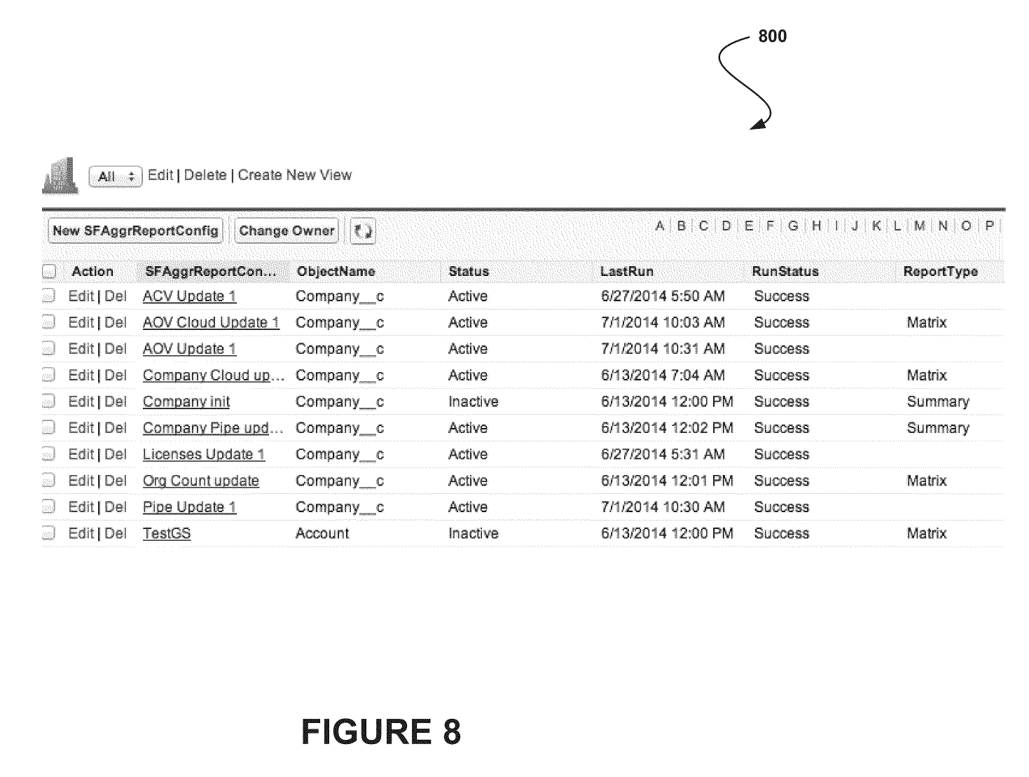

FIG. 8 is a screen shot 800 illustrating an exemplary user interface showing multiple user-configured uses for reports that aggregate data, in accordance with an embodiment. As shown, the user can create multiple use configurations described above with reference to FIG. 6, which are listed in present screen shot 800 by configuration record. This enables the data aggregation process to be automated for multiple use cases.

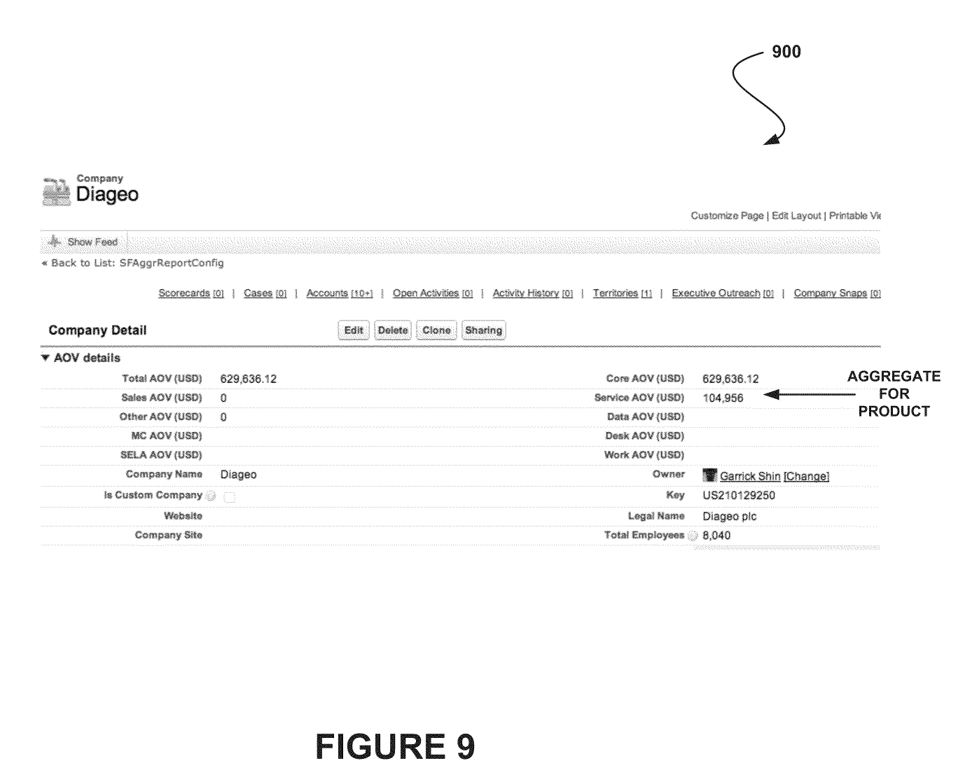

FIG. 9 is a screen shot 900 illustrating an exemplary user interface showing a database object that has been updated with report aggregations, in accordance with an embodiment. As shown, a record updated as a result of the execution of the above described report is displayed, namely with revenue figures (i.e. AOV) broken by products (Sales AOV, Service AOV, etc.).

### System Overview

FIG. 10 illustrates a block diagram of an environment 1010 wherein an on-demand database service might be used. Environment 1010 may include user systems 1012, network 1014, system 1016, processor system 1017, application platform 1018, network interface 1020, tenant data storage 1022, system data storage 1024, program code 1026, and process space 1028. In other embodiments, environment 1010 may not have all of the components listed and/or may have other elements instead of, or in addition to, those listed above.

Environment 1010 is an environment in which an on-demand database service exists. User system 1012 may be any machine or system that is used by a user to access a database user system. For example, any of user systems 1012 can be a handheld computing device, a mobile phone, a laptop computer, a work station, and/or a network of computing devices. As illustrated in FIG. 10 (and in more detail in FIG. 11) user systems 1012 might interact via a network 1014 with an on-demand database service, which is system 1016.

An on-demand database service, such as system 1016, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 1016” and “system 1016” will be used interchangeably herein. A database image may include one or more database objects. A relational database management system (RDMS) or the equivalent may execute storage and retrieval of information against the database object(s). Application platform 1018 may be a framework that allows the applications of system 1016 to run, such as the hardware and/or software, e.g., the operating system. In an embodiment, on-demand database service 1016 may include an application platform 1018 that enables creation, managing and executing one or more applications developed by the provider of the on-demand database service, users accessing the on-demand database service via user systems 1012, or third party application developers accessing the on-demand database service via user systems 1012.

The users of user systems 1012 may differ in their respective capacities, and the capacity of a particular user system 1012 might be entirely determined by permissions (permission levels) for the current user. For example, where a salesperson is using a particular user system 1012 to interact with system 1016, that user system has the capacities allotted to that salesperson. However, while an administrator is using that user system to interact with system 1016, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 1014 is any network or combination of networks of devices that communicate with one another. For example, network 1014 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 1012 might communicate with system 1016 using TCP/IP and, at a higher network level, use other common Internet protocols to communicate, such as HTTP, FTP, AFS, WAP, etc. In an example where HTTP is used, user system 1012 might include an HTTP client commonly referred to as a “browser” for sending and receiving HTTP messages to and from an HTTP server at system 1016. Such an HTTP server might be implemented as the sole network interface between system 1016 and network 1014, but other techniques might be used as well or instead. In some implementations, the interface between system 1016 and network 1014 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 1016, shown in FIG. 10, implements a web-based customer relationship management (CRM) system. For example, in one embodiment, system 1016 includes application servers configured to implement and execute CRM software applications as well as provide related data, code, forms, webpages and other information to and from user systems 1012 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 1016 implements applications other than, or in addition to, a CRM application. For example, system 1016 may provide tenant access to multiple hosted (standard and custom) applications, including a CRM application. User (or third party developer) applications, which may or may not include CRM, may be supported by the application platform 1018, which manages creation, storage of the applications into one or more database objects and executing of the applications in a virtual machine in the process space of the system 1016.

One arrangement for elements of system 1016 is shown in FIG. 10, including a network interface 1020, application platform 1018, tenant data storage 1022 for tenant data 1023, system data storage 1024 for system data 1025 accessible to system 1016 and possibly multiple tenants, program code 1026 for implementing various functions of system 1016, and a process space 1028 for executing MTS system processes and tenant-specific processes, such as running applications as part of an application hosting service. Additional processes that may execute on system 1016 include database indexing processes.

Several elements in the system shown in FIG. 10 include conventional, well-known elements that are explained only briefly here. For example, each user system 1012 could include a desktop personal computer, workstation, laptop, PDA, cell phone, or any wireless access protocol (WAP) enabled device or any other computing device capable of interfacing directly or indirectly to the Internet or other network connection. User system 1012 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 1012 to access, process and view information, pages and applications available to it from system 1016 over network 1014. Each user system 1012 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 1016 or other systems or servers. For example, the user interface device can be used to access data and applications hosted by system 1016, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 1012 and all of its components are operator configurable using applications, such as a browser, including computer code run using a central processing unit such as an Intel Pentium® processor or the like. Similarly, system 1016 (and additional instances of an MTS, where more than one is present) and all of their components might be operator configurable using application(s) including computer code to run using a central processing unit such as processor system 1017, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 1016 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 1016 is configured to provide webpages, forms, applications, data and media content to user (client) systems 1012 to support the access by user systems 1012 as tenants of system 1016. As such, system 1016 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 11 also illustrates environment 1010. However, in FIG. 11 elements of system 1016 and various interconnections in an embodiment are further illustrated. FIG. 11 shows that user system 1012 may include processor system 1012A, memory system 1012B, input system 1012C, and output system 1012D. FIG. 11 shows network 1014 and system 1016. FIG. 11 also shows that system 1016 may include tenant data storage 1022, tenant data 1023, system data storage 1024, system data 1025, User Interface (UI) 1130, Application Program Interface (API) 1132, PL/SOQL 1134, save routines 1136, application setup mechanism 1138, applications servers 1100₁-1100_{N}, system process space 1102, tenant process spaces 1104, tenant management process space 1110, tenant storage area 1112, user storage 1114, and application metadata 1116. In other embodiments, environment 1010 may not have the same elements as those listed above and/or may have other elements instead of, or in addition to, those listed above.

User system 1012, network 1014, system 1016, tenant data storage 1022, and system data storage 1024 were discussed above in FIG. 10. Regarding user system 1012, processor system 1012A may be any combination of one or more processors. Memory system 1012B may be any combination of one or more memory devices, short term, and/or long term memory. Input system 1012C may be any combination of input devices, such as one or more keyboards, mice, trackballs, scanners, cameras, and/or interfaces to networks. Output system 1012D may be any combination of output devices, such as one or more monitors, printers, and/or interfaces to networks. As shown by FIG. 11, system 1016 may include a network interface 1020 (of FIG. 10) implemented as a set of HTTP application servers 1100, an application platform 1018, tenant data storage 1022, and system data storage 1024. Also shown is system process space 1102, including individual tenant process spaces 1104 and a tenant management process space 1110. Each application server 1100 may be configured to tenant data storage 1022 and the tenant data 1023 therein, and system data storage 1024 and the system data 1025 therein to serve requests of user systems 1012. The tenant data 1023 might be divided into individual tenant storage areas 1112, which can be either a physical arrangement and/or a logical arrangement of data. Within each tenant storage area 1112, user storage 1114 and application metadata 1116 might be similarly allocated for each user. For example, a copy of a user's most recently used (MRU) items might be stored to user storage 1114. Similarly, a copy of MRU items for an entire organization that is a tenant might be stored to tenant storage area 1112. A UI 1130 provides a user interface and an API 1132 provides an application programmer interface to system 1016 resident processes to users and/or developers at user systems 1012. The tenant data and the system data may be stored in various databases, such as one or more Oracle™ databases.

Application platform 1018 includes an application setup mechanism 1138 that supports application developers' creation and management of applications, which may be saved as metadata into tenant data storage 1022 by save routines 1136 for execution by subscribers as one or more tenant process spaces 1104 managed by tenant management process 1110 for example. Invocations to such applications may be coded using PL/SOQL 1134 that provides a programming language style interface extension to API 1132. A detailed description of some PL/SOQL language embodiments is discussed in commonly owned U.S. Pat. No. 7,730,478, entitled “METHOD AND SYSTEM FOR ALLOWING ACCESS TO DEVELOPED APPLICATIONS VIA A MULTI-TENANT ON-DEMAND DATABASE SERVICE,” issued Jun. 1, 2010 to Craig Weissman, hereby incorporated in its entirety herein for all purposes. Invocations to applications may be detected by one or more system processes, which manages retrieving application metadata 516 for the subscriber making the invocation and executing the metadata as an application in a virtual machine.

Each application server 1100 may be communicably coupled to database systems, e.g., having access to system data 1025 and tenant data 1023, via a different network connection. For example, one application server 1100₁ might be coupled via the network 1014 (e.g., the Internet), another application server 1100_{N-1} might be coupled via a direct network link, and another application server 1100_{N} might be coupled by yet a different network connection. Transfer Control Protocol and Internet Protocol (TCP/IP) are typical protocols for communicating between application servers 1100 and the database system. However, it will be apparent to one skilled in the art that other transport protocols may be used to optimize the system depending on the network interconnect used.

In certain embodiments, each application server 1100 is configured to handle requests for any user associated with any organization that is a tenant. Because it is desirable to be able to add and remove application servers from the server pool at any time for any reason, there is preferably no server affinity for a user and/or organization to a specific application server 1100. In one embodiment, therefore, an interface system implementing a load balancing function (e.g., an F5 Big-IP load balancer) is communicably coupled between the application servers 1100 and the user systems 1012 to distribute requests to the application servers 1100. In one embodiment, the load balancer uses a least connections algorithm to route user requests to the application servers 1100. Other examples of load balancing algorithms, such as round robin and observed response time, also can be used. For example, in certain embodiments, three consecutive requests from the same user could hit three different application servers 1100, and three requests from different users could hit the same application server 1100. In this manner, system 1016 is multi-tenant, wherein system 1016 handles storage of, and access to, different objects, data and applications across disparate users and organizations.

As an example of storage, one tenant might be a company that employs a sales force where each salesperson uses system 1016 to manage their sales process. Thus, a user might maintain contact data, leads data, customer follow-up data, performance data, goals and progress data, etc., all applicable to that user's personal sales process (e.g., in tenant data storage 1022). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 1016 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1016 might also maintain system level data usable by multiple tenants or other data. Such system level data might include industry reports, news, postings, and the like that are sharable among tenants.

In certain embodiments, user systems 1012 (which may be client systems) communicate with application servers 1100 to request and update system-level and tenant-level data from system 1016 that may require sending one or more queries to tenant data storage 1022 and/or system data storage 1024. System 1016 (e.g., an application server 1100 in system 1016) automatically generates one or more SQL statements (e.g., one or more SQL queries) that are designed to access the desired information. System data storage 1024 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, entitled “CUSTOM ENTITIES AND FIELDS IN A MULTI-TENANT DATABASE SYSTEM”, issued Aug. 27, 2010 to Craig Weissman, and hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed by a computer to implement a method comprising:
receiving from a user a definition of a report that aggregates source data from a plurality of source objects in a database system;
receiving from the user configuration information mapping the aggregated data in the report to at least one destination object in the database system;
executing the report to generate the aggregated data; and
in response to generation of the aggregated data, automatically updating each of the at least one destination object with the aggregated data based on the configuration information.

2. The computer program product of claim 1, wherein the source objects are tables of the database system.

3. The computer program product of claim 1, wherein the destination object is a table of the database system.

4. The computer program product of claim 1, wherein the definition of the report specifies a field of the source objects for retrieving the source data, an aggregate function for aggregating the source data, and a level of aggregation for the source data.

5. The computer program product of claim 4, wherein executing the report includes retrieving the source data from the field of the source objects, an applying the aggregate function to the source data at the specified level of aggregation.

6. The computer program product of claim 5, wherein the definition of the report further specifies filtering criteria for filtering the source data that is aggregated by the aggregate function.

7. The computer program product of claim 1, wherein the report is stored in a report object of the database system.

8. The computer program product of claim 7, wherein the configuration information maps the aggregated data in the report to the at least one destination object by mapping a field of the report object designated for storing the aggregated data to a field of the at least one destination object.

9. The computer program product of claim 8, wherein updating each of the at least one destination object with the aggregated data based on the configuration includes retrieving the aggregated data from the field of the report object and storing the retrieved aggregated data in the field of the at least one destination object.

10. The computer program product of claim 1, wherein the configuration information specifies a schedule for executing the report.

11. The computer program product of claim 10, wherein the report is executed according to the schedule for updating each of the at least one destination object with the aggregated data.

12. The computer program product of claim 10, wherein the schedule specifies a recurring execution of the report to generate the aggregated data.

13. The computer program product of claim 12, wherein in response to each execution of the report in accordance with the schedule, each of the at least one destination object is updated with the generated aggregated data.

14. The computer program product of claim 1, wherein the configuration information is stored in a configuration object of the database system.

15. The computer program product of claim 1, wherein the definition of the report and the configuration information is stored in the database system as metadata.

16. The computer program product of claim 1, further comprising logging the execution of the report and the updating of the at least one destination object with the aggregated data.

17. The computer program product of claim 16, wherein the logging is of a status of the execution of the report and the updating of the at least one destination object with the aggregated data.

18. The computer program product of claim 16, wherein the logging is of errors occurring during the execution of the report and the updating of the at least one destination object with the aggregated data.

19. A method, comprising:
receiving from a user a definition of a report that aggregates source data from a plurality of source objects in a database system;
receiving from the user configuration information mapping the aggregated data in the report to at least one destination object in the database system;
executing the report to generate the aggregated data; and
in response to generation of the aggregated data, automatically updating each of the at least one destination object with the aggregated data based on the configuration information.

20. An apparatus, comprising:
a processor for:
receiving from a user a definition of a report that aggregates source data from a plurality of source objects in a database system;
receiving from the user configuration information mapping the aggregated data in the report to at least one destination object in the database system;
executing the report to generate the aggregated data; and
in response to generation of the aggregated data, automatically updating each of the at least one destination object with the aggregated data based on the configuration information.
